(19) United States
(12) Patent Application Publication
(10) Pub. No.: US 2005/0108890 A1
(43) Pub. Date: May 26, 2005

(54) Hair dryer

(76) Inventor: Su-Hong Park, Inchon (KR)

Correspondence Address: PARK & SUTTON LLP, 3255 WILSHIRE BLVD, SUITE 1110, LOS ANGELES, CA, 90010, US

(21) Appl. No.: 11/034,079

(22) Filed: Jan. 12, 2005

Related U.S. Application Data
(63) Continuation-in-part of application No. 10/420,088, filed on Apr. 22, 2003, now abandoned.

(30) Foreign Application Priority Data
Apr. 22, 2002 (KR) 20-2002-0012176

(51) Int. Cl. A45D 1/00; F26B 3/34

(52) U.S. Cl. 34/96; 34/245

(57) ABSTRACT

Disclosed is the hair dryer. In the hair dryer, a hollow dryer housing has an inlet port, an outlet port and a front handle. An intake cover is coupled to a rear side of the dryer housing and has a rear handle protruding downwardly from the hollow dryer, for suctioning an outer air into the dryer housing. A nozzle is coupled to the outlet port of the dryer housing. A heating assembly is positioned in the dryer housing and in the intake cover, and includes a hollow assembly body, a support frame, a driving motor, a rotating shaft, and a blowing fan. A shielding member is installed along an inner side of the dryer housing, the intake cover, and the nozzle. Due to this structure, the hair dryer is capable of absorbing and shielding the magnetic field not to cause human problems such as headache, dermatitis and chronic fatigue.

### RELATED APPLICATION

This application is a continuation-in-part of U.S. patent application Ser. No. 10/420,088, filed Apr. 22, 2003.

### CLAIMING FOREIGN PRIORITY

The applicant claims and requests a foreign priority, through the Paris Convention for the Protection of Industry Property, based on a patent application filed in the Republic of Korea (South Korea) with the filing date of Apr. 22, 2002, with the patent application number 20-2002-0012176, by the applicant.

### BACKGROUND OF THE INVENTION

The present invention relates to a hair dryer, more particularly, it relates to a hair dryer having a shielding function against magnetic field, which is used for drying and styling hair.

A hair dryer, which applies an electrical power of a power supplying part to a dryer body, is used to dry and style the hair by blowing warm or cool air.

Various technical models of the hair dryer have been proposed. The common type of hair dryer will be described herein with reference to FIG. 7. FIG. 7 is an exploded perspective view showing a generic hair dryer 100. As shown in FIG. 7, the hair dryer 100 mainly includes a dryer housing 110, an intake cover 120, and a nozzle 130. An inlet port 112 and an outlet port 114 are formed at the interior of the dryer housing 110. A front handle 116 protrudes downwardly from the lower end of an outer surface of the dryer housing 110. The intake cover 120 is coupled with the rear side of the dryer housing cover 110. A rear handle 124 corresponding to the front handle 116 protrudes downwardly from the lower end of an outer surface of the intake cover 120. The air inlet 122 is formed at an opening portion of a one side of the intake cover 120. The nozzle 130 is coupled to the outlet port 114 of the dryer housing 120. A discharge grille 132 is vertically installed at the rear end of the interior of the nozzle 130.

The hair dryer 100 further comprises a heating assembly 140 that is installed at the interior of the dryer housing 110 and the intake cover 120. The heating assembly 140 has an assembly body 142, a driving motor 146, and a blowing fan 148. A support frame 144 protrudes from the front side of the assembly body 142. The driving motor 146 is mounted on the interior of the assembly body 142, and a part of which is inserted into the support frame 144. A rotation shaft (not shown) projects out of the rear side of the driving motor 146. The blowing fan 148 is forcibly inserted into the rotation shaft (not shown) of the driving motor 146 so that the blowing fan 148 blows outside air out of the inlet port 112 to the outlet port 114 by the rotation of the driving motor 146.

Further, the hair dryer 100 includes an electrical cord 150, an electrical switch 152, and a heating wire 154. The electrical cord 150 supplies an electrical power to the driving motor 146. The electrical switch 152 is connected to the electrical cord 150, which controls the opening and closing of the electrical power. The heating wire 154 winds around the support frame 144 for heating sucked air through the inlet port 112 of the dryer housing 110.

In the conventional hair dryer structured as above, when the hair dryer 100 is operated by turning on the electrical switch 152, the electrical power from the electrical power supplying part (not shown) is supplied to the driving motor 146 and the heating wire 154 through the electrical cord 150. The driving motor 146 is rotated in a predetermined speed of revolution, and the heating wire 154 generates heat to a predetermined temperature.

In this state, the user turns the nozzle 130 of the dryer housing 110 toward his head and dries and styles the hair by blowing warm or cool air.

The heating wire 154 and the driving motor 146 of the heating assembly 140 generate an electromagnetic field with the supplied electrical power. The heating wire 154 and the driving motor 146 are composed of a magnet, an armature coil and a rotator coil. Thus, an electromagnetic wave, which is composed of an electronic field and a magnetic field, is generated by the electromagnetic field. The electromagnetic wave accordingly kills the living cells or damages the hair by upsetting the nerve system. Moreover, it causes problems for human beings such as headache, dermatitis and chronic-fatigue. Furthermore, a conductive material easily shields the electric field of the electromagnetic wave but easily fails to shield the magnetic field. Thus, there is the problem that the magnetic field is directly transmitted to the body of the user.

Accordingly, a need for a hair dryer with a capability to shield the magnetic field has been present for a long time. This invention is directed to solve these problems and satisfy the long-felt need.

### SUMMARY OF THE INVENTION

The present invention solves the foregoing problems. It is an object of the present invention to provide a hair dryer that prevents transmitting of the magnetic field to the user of the hair dryer by installing a shielding member in the interior of the dryer housing.

In order to achieve the above objects, the present invention provides a hair dryer comprising:
a hollow dryer housing having an inlet port, an outlet port and a front handle, the inlet port being formed at one end of the dryer housing, the outlet port being formed at the other end of the dryer housing, and the front handle protruding downwardly from the hollow dryer;
an intake cover which is coupled to a rear side of the dryer housing and which has a rear handle protruding downwardly from the hollow dryer so as to correspond to the front handle, for suctioning an outer air into the dryer housing;
a nozzle which is coupled to the outlet port of the dryer housing, for discharging warm or cool air to the outside of the dryer housing;
a heating assembly which is positioned in the dryer housing and in the intake cover, and which includes a hollow assembly body, a support frame, a driving motor, a rotating shaft, and a blowing fan, the support frame protruding from a front side of the assembly body, the driving motor being installed at an inner side of the assembly body so as to project toward the support frame, the rotating shaft protruding from the rear side of the driving motor, and driving motor being positioned at an inner side of the dryer body and the intake cover, for blowing a heated air to a predetermined temperature through the outlet port of the dryer housing; and
a shielding member which is installed along an inner side of the dryer housing, the intake cover, and the nozzle, for absorbing and shielding an magnetic field which is generated according to the operation of the heating assembly.

The heating wire can be wound around the support frame in a plain pleat of the shape of band.

For this band type, the shielding member is the alloy for which the relative permeability is more than 100,000. An alloy based on Fe and Ni, called mu metal, is used to obtain the relative permeability of higher than 100,000.

The hair dryer further includes an insulating member to enclose the heating wire and the support frame and insulate the rest of the part of the hair dryer thermally and electrically from the heating wire. The insulating member is made of mica.

The shielding member is an alloy consisting of Ni of from about 46.2% to about 46.4%, Si of from about 0.152% to about 0.2%, Mn of from about 0.9% to about 1.0%, C of from about 0.006% to about 0.01% and Fe of the remainder, based on the total weight of the alloy.

As described above, in the hair dryer according to the preferred embodiment of the present invention, the hair dryer is capable of absorbing and shielding the magnetic field generated around the driving motor and the heating assembly.

Although the present invention is briefly summarized, the fuller understanding of the invention can be obtained by the following drawings, detailed description and appended claims.

### BRIEF DESCRIPTION OF THE DRAWINGS

The above objects and other characteristics and advantages of the present invention will become more apparent by describing in detail embodiments thereof with reference to the attached drawings, in which:

FIG. 1 is a sectional view showing an installed state of a shielding member at a portion of a heating wire of the hair dryer according to the first embodiment of the present invention;

FIG. 2 is a sectional view showing an installed state of a shielding member at a portion of a driving motor of the hair dryer according to the second embodiment of the present invention;

FIG. 3 is a sectional view showing an installed state of a shielding member at a portion of a blowing fan of the hair dryer according to the third embodiment of the present invention;

FIG. 4 is a sectional view showing an installed state of a shielding member at a portion of a nozzle of the hair dryer according to the fourth embodiment of the present invention;

FIG. 5 is a sectional view showing an installed state of a shielding member at a portion of a discharge grill of the hair dryer according to the fifth embodiment of the present invention;

FIG. 6 is an exploded perspective view showing a hair dryer according to the invention; and

FIG. 7 is an exploded perspective view showing a generic hair dryer.

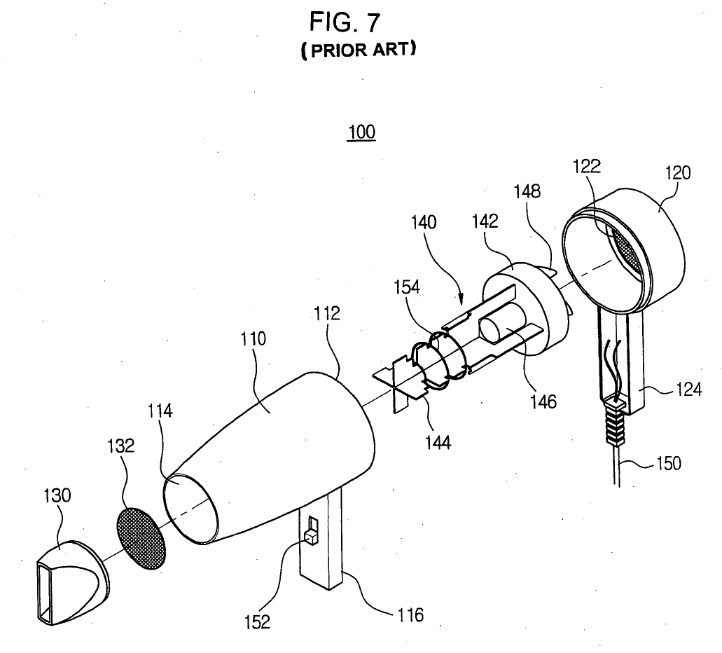

### DETAILED DESCRIPTION OF THE INVENTION

Hereinafter, the hair dryer according to embodiments of the present invention will be explained in more detail with reference to the accompanying drawings.

### EXAMPLE 1

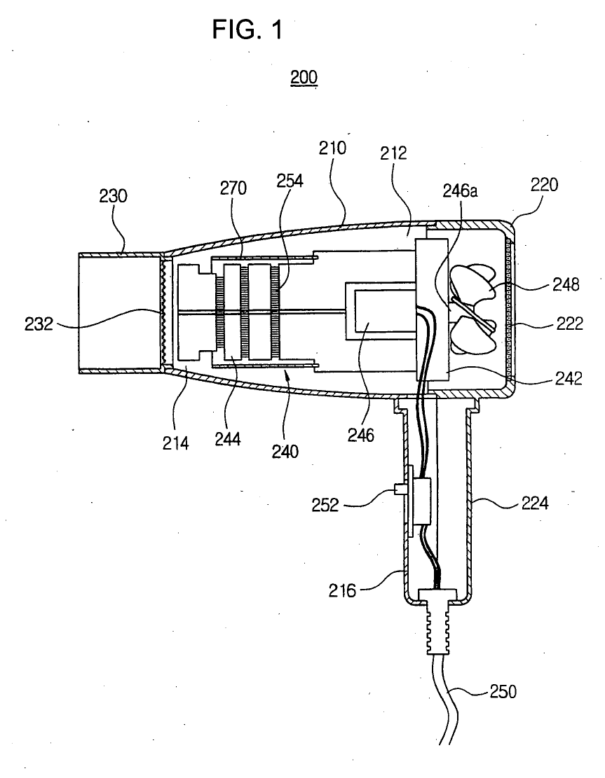

FIG. 1 is a view showing an installed state of a shielding member 270 at a portion of a heating wire 254 of a hair dryer 200 according to the first embodiment of the present invention.

Referring to FIG. 1, the hair dryer 200 includes a dryer housing 210, an intake cover 220 and a nozzle 230. Further, a heating assembly 240 is installed at the interior of the dryer housing 210 and the intake cover 220.

An inlet port 212 and an outlet port 214 are formed at both ends of the interior of the dryer housing 210. In other words, the inlet port 212 is formed at one end of the dryer housing 210, and the outlet port 214 is formed at the other end of the dryer housing 210. A front handle 216 protrudes downwardly from an outer periphery surface of the dryer housing 210. The intake cover 220 is coupled to the rear side of the dryer housing 210.

An air inlet 222 is integrally formed with an outer surface of the intake cover 220.

A rear handle 224 corresponding to the front handle 216 protrudes downwardly from the lower end of an outer periphery surface of the intake cover 220. When the intake cover 220 is coupled to the dryer housing 210, the front handle 216 is coupled to the rear handle 224.

The nozzle 230 is mounted in the outlet port 214 of the dryer housing 210. A discharge grille 232 is mounted between the nozzle 230 and the outlet port 214.

An electrical cord 250 is inserted into the lower end of the front handle 216 and the rear handle 224 when the front handle 216 is coupled with the rear handle 224. Preferably, an electrical switch 252 is installed at the front handle 216, but the electrical switch 252 is not limited to the above-mentioned embodiment. The heating wire 254 is wound around the support frame 244 as also explained in more detail later herein.

The heating assembly 240 includes an assembly body 242, a support frame 244, a driving motor 246 and a blowing fan 248. The support frame 244 protrudes from a front side of the assembly body 242. A plurality of fixing recess (not shown) is formed on an outer periphery edge of the support frame 244. The driving motor 246 is provided within an interior of the assembly body 242, and inserted into the support frame 244. A rotating shaft 246a of the driving motor 246 is projected opposite to the support frame 244. A blowing fan 248 is forcibly assembled with the rotating shaft 246a of the driving motor 246.

The shielding member 270 is installed along an interior of the dryer housing 210, the intake cover 220, and the nozzle 230. The shielding member 270 is formed in a cylinder-shape. Preferably, the shielding member 270 is installed at the support frame 244 to wrap the heating wire 254. The shielding member 270 is an alloy consisting of Ni, Si, Mn, C and Fe. Preferably, based on the total weight of the alloy, the shielding member 270 is the alloy consisting of 47.6 wt. % Ni, 0.101 wt. % Si, 0.47 wt. % Mn, 0.006 wt. % C and 51, 823 wt. % Fe.

Hereinafter, the operation of the hair dryer according to the first embodiment of the present invention as above will be described in detail.

At first, to dry and style the washed hair, the user turns on the electrical switch 252, which is installed at the front handle 216 of the dryer housing 210. At this time, an electrical power is supplied to the driving motor 246 and the heating wire 254 through the electrical cord 250 from an electrical power supplying part (not shown).

Thus, the driving motor 246 is rotated in a predetermined speed of revolution by the supplied electrical power. Simultaneously, the heating wire 254 generates heat to a predetermined temperature with the supplied electrical power. Generally, the speed of revolution of the driving motor 246 and the temperature of the heat of the heating wire 254 have the high function, the medium function and low function. The functions are controlled by the demands of the user. Additionally, the hair dryer 100 can select cool air instead of the heat of the heating wire 254.

At this state, the driving motor 246 rotates the blowing fan 248 so that outer air is sucked into the interior of the dryer housing 210 of the hair dryer 200 through the air inlet 222 of the intake cover 220. After the heating wire 254 heats the sucked air, it is passed through the outlet port 214 of the dryer housing 210, the nozzle 230, and the discharge grille 232. Thus, the sucked air is blown toward the outside of the dryer housing 210. Therefore, the hair dryer 200 can be used to dry and style the user's hair by selectively blowing warm or cool air.

In this process, during the heating process of the heating wire 254, the magnetic field is generated around the heating wire 254 with the supplied electrical power. At this time, the shielding member 270, which is mounted on the support frame 244 for wrapping the outer surface of the heating wire 254, absorbs and shields the magnetic field from the heating wire 254 not to pass through the dryer housing 210.

### EXAMPLE 2

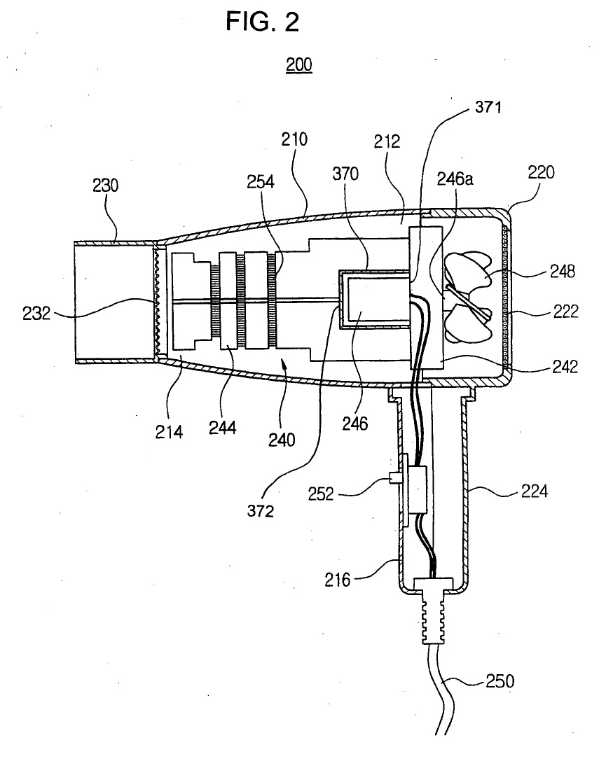

FIG. 2 is a view showing an installed state of a shielding member 370 at a portion of the driving motor 246 of the hair dryer 200 according to the second embodiment of the present invention.

As shown in FIG. 2, preferably, the shielding member 370 is cap-shaped, which has an opened portion 371 at a one surface of thereof. The opened portion 371 of the shielding member 370 is mounted on the front surface of the assembly body 242, and the other portion 372 is in contact with the support frame 244. Thus, the shielding member 370 covers the driving motor 246.

At this state, the user turns on the electrical switch 252 of the hair dryer 200. And then, the driving motor 246 is rotated by the signal of the electrical switch 252. With this process, the magnetic field, which is generated around the driving motor 246, is absorbed and shielded by the shielding member 370.

In other words, the shielding member 370 prevents magnetic field from transmitting the outside of the dryer housing 210.

### EXAMPLE 3

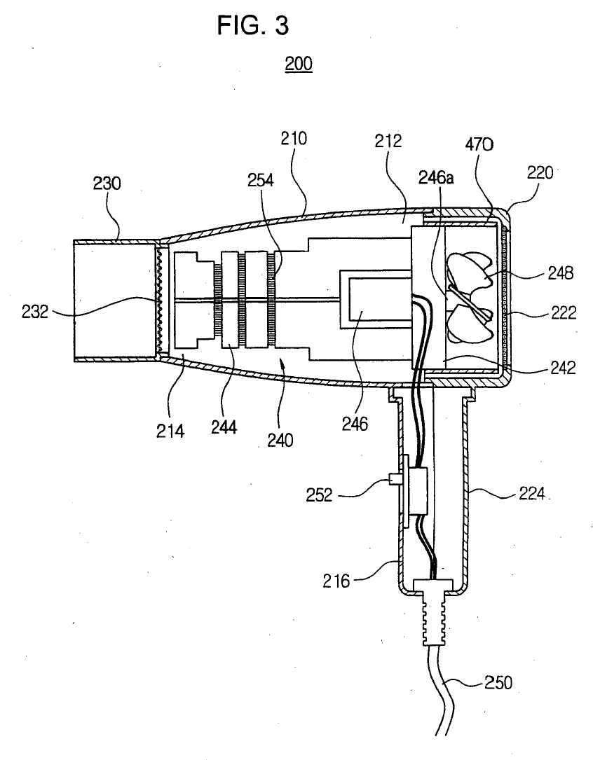

FIG. 3 is a view showing an installed state of a shielding member 470 at a portion of the blowing fan 248 of the hair dryer 200 according to the third embodiment of the present invention.

As shown in FIG. 3, preferably, the shielding member 470 is cylindrical shaped. One end of the shielding member 470 receives the rear side of the assembly body 242 so as to cover the blowing fan 248. Preferably, the shielding member 470 is spaced from the intake cover 220 and the air inlet 222. Alternatively, the shielding member 470 may be contacted with the intake cover 220 and the air inlet 222.

In this state, when the user turns on the electrical switch 252 of the hair dryer 200, the driving motor 246, is driven and the heating wire 254 is heated. The magnetic field is generated around the driving motor 246 and the heating wire 254, and then the magnetic field may be leaked to the intake cover 220. With this construction, the magnetic field, which is generated around the driving motor 246, is absorbed and shielded by the shielding member 470. In other words, the shielding member 470 prevents the magnetic field from transmitting the outside of the dryer housing 210.

### EXAMPLE 4

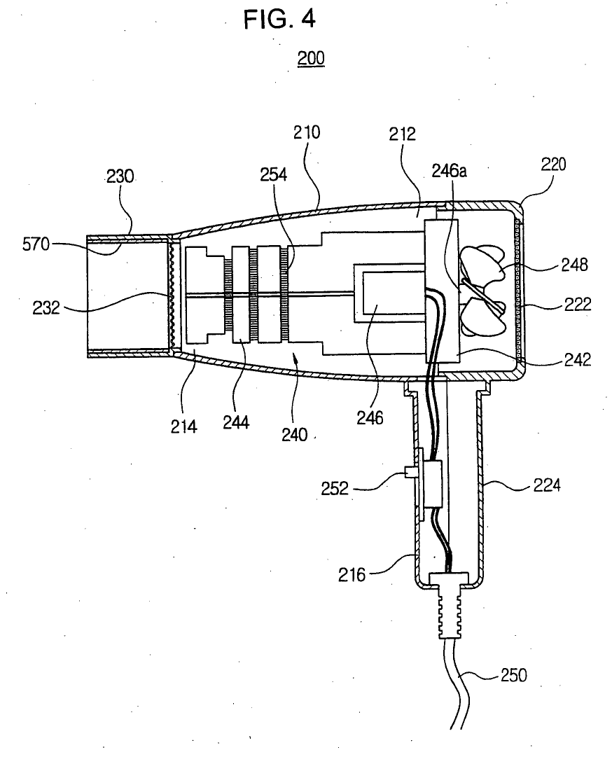

FIG. 4 is a view showing an installed state of a shielding member 570 at a portion of the nozzle 230 of the hair dryer 200 according to the fourth embodiment of the present invention.

As shown in FIG. 4, the shielding member 570 is mounted on an inner side wall of the nozzle 230. Preferably, the shielding member 570 is cylindrical shaped.

In this state, when the user turns on the electrical switch 252 of the hair dryer 200, the driving motor 246 is driven, and the heating wire 254 is heated. The magnetic field is generated around the driving motor 246 and the heating wire 254, and then the magnetic field may be leaked out through the outlet port 214, the discharge grille 232 and the nozzle 230. With this construction, the magnetic field, which is generated around the driving motor 246 and the heating assembly 254, is absorbed and shielded by the shielding member 570. In other words, the shielding member 570 prevents the magnetic field from transmitting the outside of the dryer housing 210.

### EXAMPLE 5

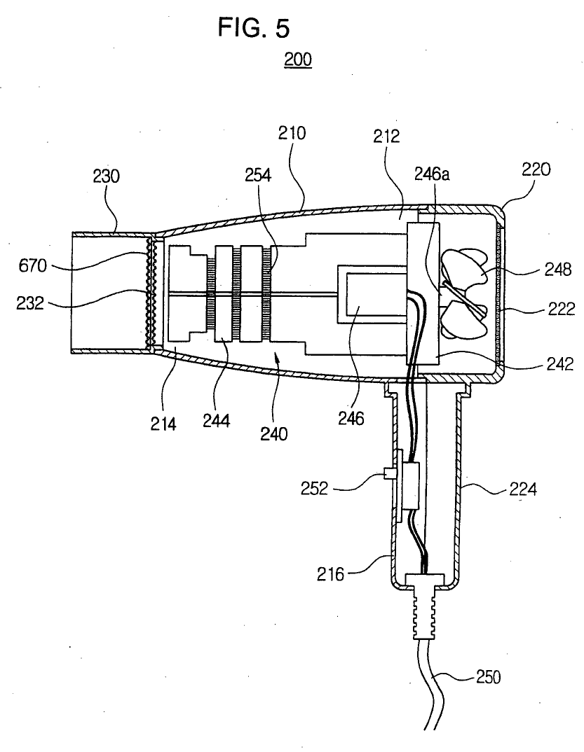

FIG. 5 is a view showing an installed state of a shielding member 670 at a portion of the discharge grill 232 of the hair dryer 200 according to the fifth embodiment of the present invention.

As shown in FIG. 5, the shielding member 670 is vertically installed at the rear end of the nozzle 230. The shielding member 670 is contacted with one side of the discharge grille 232. Preferably, the shielding member 570 is cylindrical shaped. The shielding member 670 is net-shaped to pass through the warm or cool air from the outlet port 214 of the assembly body 242.

In this state, when the user turns on the electrical switch 252 of the hair dryer 200, the driving motor 246 is driven, and the heating wire 254 is heated. The magnetic field is generated around the driving motor 246 and the heating wire 254, and then the magnetic field may be leaked out through the outlet port 214, the discharge grille 232 and the nozzle 230. With this construction, the magnetic field, which is generated around the driving motor 246 and the heating assembly 254, is absorbed and shielded by the shielding member 670. In other words, the shielding member 670 prevents the magnetic field from transmitting the outside of the dryer housing 210.

In the hair dryer according to the embodiments of the present invention constructed as described above, the shielding member is mounted on the inner side of the dryer housing of the hair dryer. Due to this structure, the hair dryer as described above is capable of absorbing and shielding the magnetic field generated around the driving motor and the heating assembly. Accordingly, the hair dryer prevents the magnetic field from killing of the living cells or damaging of the hair by upsetting the nerve system. Moreover, it prevents the magnetic field from causing human problems such as headache, dermatitis and chronic fatigue.

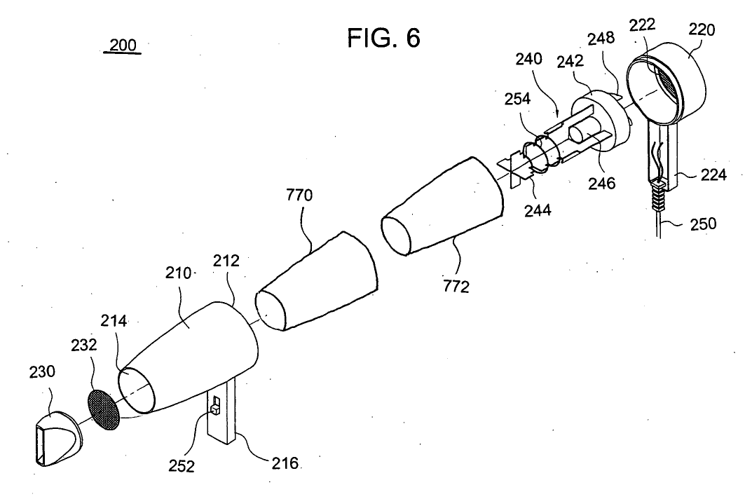

FIG. 6 shows an exploded perspective view of the hair dryer 200 according to the invention. An insulating member 772 is made of mica, inserted between a shielding member 770 and the heating wire 254, and protects the other parts of the hair dryer 200 from the heat of the heating wire 254 and protects a human body from the electric shock.

The magnitude of the magnetic field from the hair dryer 200 depends on the way to wind the heating wire 254. There are many ways to wind the heating wire 254 around the support frame 244.

If the heating wire 254 is wound around the support frame 244 in a shape of simple winding without pleats (band-type), the magnitude of the magnetic field is very strong. With this shape of winding, the shielding member 244 made of material with a relatively high permeability, about 100,000, can be used. Based on the total weight of the alloy, the composition of alloy for the shielding member 770 is shown in the following table.

| | |
|---|---|
| Chemical | Weight % |

| Composition(%) | MAX | MIN |
|---|---|---|
| C | 0.01 | 0.006 |
| Si | 0.2 | 0.152 |
| Mn | 1.0 | 0.9 |
| Ni | 46.4 | 46.2 |
| Fe | Remainder | Remainder |

The magnetic field from the hair dryer 200 with or without the invention applied was measured, and then compared with the magnetic field from several commercially available hair dryers from the other manufacturers.

UN-0570T (1200W): an Embodiment of the Invention

| | Before [mG] | After [mG] | Shielding rate |
|---|---|---|---|
| Cold wind | 6.7 | 0.9 | 86.6% |
| Low wind | 7.0 | 1.6 | 77.1% |
| High wind | 6.6 | 0.9 | 86.4% |
| Average | 6.77 | 1.13 | 83.0% |

Vidal Sasson (1600W)

| | Magnetic field [mG] | Relative rate | Compared to |
|---|---|---|---|
| Step 1 | 8.5 | 425% | Low wind |
| Step 2 | 14.2 | 710% | High wind |
| Average | 11.35 | 568% | |

Helen of Trov (1600W, S035)

| | Magnetic field [mG] | Relative rate | Compared to |
|---|---|---|---|
| Step 1 | 9.5 | 475% | Low wind |
| Step 2 | 14.2 | 710% | High wind |
| Step 3 | 16.7 | 835% | High wind |
| Average | 13.47 | 673% | |

Morphy of Richards (1800˜2000W, 21010)

| | Magnetic field [mG] | Relative rate | Compared to |
|---|---|---|---|
| Step 1 | 13.7 | 685% | Low wind |
| Step 2 | 16.3 | 815% | High wind |
| Step 3 | 35.6 | 1780% | High wind |
| Average | 21.87 | 1093% | |

Conair (1600W, 169C)

| | Magnetic field [mG] | Relative rate | Compared to |
|---|---|---|---|
| Step 1 | 2.7 | 135% | Low wind |
| Step 2 | 42.4 | 2120% | High wind |
| Average | 22.55 | 1128% | |

GF-1505 (1500W)

| | Magnetic field [mG] | Relative rate | Compared to |
|---|---|---|---|
| Step 1 | 10.2 | 510% | Low wind |
| Step 2 | 17.9 | 895% | High wind |
| Average | 14.05 | 703% | |

GF-1505 (1500W): an Embodiment of the Invention

| | Before [mG] | After [mG] | Shielding rate |
|---|---|---|---|
| Low wind | 9.13 | 1.09 | 88.1% |
| High wind | 17.87 | 1.36 | 92.4% |
| Average | 13.50 | 1.23 | 90.0% |

Koizmi (700W, V91˜44334)

| | Magnetic field [mG] | Relative rate | Compared to |
|---|---|---|---|
| Cold | 1.0 | 50% | Low wind |
| High | 8.1 | 405% | High wind |
| Average | 4.45 | 228% | |

Philips (1650W, HP-4870)

| | Magnetic field [mG] | Relative rate | Compared to |
|---|---|---|---|
| Step 1 | 14.8 | 740% | Low wind |
| Step 2 | 14.1 | 705% | High wind |
| Step 3 | 14.8 | 740% | High wind |
| Average | 14.57 | 728% | |

IGIA (800W, AT6664)

| | Magnetic field [mG] | Relative rate | Compared to |
|---|---|---|---|
| Cold | 1.6 | 80% | Low wind |
| Low | 2.8 | 140% | High wind |
| High | 5.2 | 260% | High wind |
| Average | 3.20 | 160% | |

Windmere Products (1600W, AM-160T/401)

| | Magnetic field [mG] | Relative rate | Compared to |
|---|---|---|---|
| Low | 5.2 | 260% | Low wind |
| High | 2.7 | 135% | High wind |
| Average | 3.95 | 198% | |

National (1200W, EH-5301)

| | Magnetic field [mG] | Relative rate | Compared to |
|---|---|---|---|
| Set | 9.9 | 495% | Low wind |
| Dry | 15.2 | 760% | High wind |
| Turbo | 17.0 | 850% | High wind |
| Average | 14.03 | 702% | |

Sanyo (1200W, HD-IP1)

| | Magnetic field [mG] | Relative rate | Compared to |
|---|---|---|---|
| Hair Care | 28.5 | 1425% | Low wind |
| Turbo | 56.9 | 2845% | High wind |
| Average | 42.70 | 2135% | |

While the present invention has been particularly shown and described with reference to particular embodiments thereof, it will be understood by those skilled in the art that various changes in form and details may be effected therein without departing from the spirit and scope of the invention as defined by the appended claims.

1. A hair dryer comprising:
a) a hollow dryer housing having an inlet port, an outlet port and a front handle;
b) an intake cover which is coupled to a rear side of the dryer housing and which has a rear handle protruding downwardly from the hollow dryer;
c) a nozzle which is coupled to the outlet port of the dryer housing;
d) a heating assembly which is positioned in the interior of the dryer housing and the intake cover, and which includes a hollow assembly body, a support frame, a driving motor, a rotating shaft, and a blowing fan; and
e) a shielding member which is installed at an interior of the dryer housing, the intake cover, and the nozzle,
wherein the shielding member is an alloy consisting of Ni of from about 46.2% to about 46.4%, Si of from about 0.152% to about 0.2%, Mn of from about 0.9% to about 1.0%, C of from about 0.006% to about 0.01% and Fe of the remainder, based on the total weight of the alloy.

2. The hair dryer of claim 1, wherein the inlet port being formed at one end of the interior of the dryer housing, the outlet port being formed at the other end of the interior of the dryer housing, and the front handle protruding downwardly from outer surface of the hollow dryer.

3. The hair dryer of claim 1, wherein the support frame protruding from a front side of the assembly body, the driving motor being installed at an interior of the assembly body so as to project toward the support frame, the rotating shaft protruding from the rear side of the driving motor, and driving motor being positioned at an interior of the dryer body and the intake cover, for blowing a heated air to a predetermined temperature through the outlet port of the dryer housing.

4. The hair dryer of claim 1, wherein the shielding member absorbs and shields a magnetic field which is generated according to the operation of the heating assembly.

5. The hair dryer of claim 1, wherein the heating wire is wound around the support frame in a plain pleat of the shape of band.

6. The hair dryer of claim 5, wherein the shielding member is the alloy for which the relative permeability is more than 100,000.

7. The hair dryer of claim 1, wherein the shielding member is mounted on the support frame so as to wrap the heating wire of the heating assembly.

8. The hair dryer of claim 1, wherein the shielding member is cap-shaped having an opened portion of which is mounted on the front side of the assembly body.

9. The hair dryer of claim 1, wherein the shielding member is inserted into the rear side of the assembly body so as to wrap the blowing fan.

10. The hair dryer of claim 1, wherein the shielding member is in contact with the inner wall of the nozzle.

11. The hair dryer of claim 1, wherein the shielding member is a circular plate, the shielding member being vertically installed at a rear end of the nozzle.

12. The hair dryer of claim 1, wherein the hair dryer further comprises an insulating member, wherein the insulating member encloses the heating wire and the support frame and insulates the rest of the part of the hair dryer thermally and electrically from the heating wire.

13. The hair dryer of claim 12, wherein the insulating member is made of mica.
